(19) United States
(12) Patent Application Publication
(10) Pub. No.: US 2008/0061110 A1
(43) Pub. Date: Mar. 13, 2008

(54) System For Welding Motor Vehicle Bodies

(75) Inventors: Denny Monti, Collegno (Torino) (IT); Piero Bossotto, Torino (IT)

Correspondence Address: YOUNG & BASILE, P.C., 3001 WEST BIG BEAVER ROAD, SUITE 624, TROY, MI, 48084, US

(73) Assignee: COMAU S.P.A., Grugliasco (Torino) (IT)

(21) Appl. No.: 11/849,007

(22) Filed: Aug. 31, 2007

(30) Foreign Application Priority Data
Sep. 7, 2006 (EP) 06425622.5

(51) Int. Cl. B23K 37/04; B23K 28/00

(52) U.S. Cl. 228/6.1

(57) ABSTRACT

In a welding system comprising a welding station and various pairs of side frames, which can be positioned selectively in the welding station for clamping in the welding position bodies of different types, are provided magazines of side frames both upstream and downstream of the welding station. There are moreover provided auxiliary guide means, which connect directly together at least one magazine upstream of the welding station and at least one magazine downstream of the welding station so as to enable transfer of pairs of side frames directly from a magazine upstream to a magazine downstream or vice versa, without passing through the welding station.

### BACKGROUND OF THE INVENTION

The present invention relates to systems for welding structures constituted by stamped sheet-metal elements, such as motor-vehicle bodies or their sub-assemblies, said systems being designed to operate on a plurality of different types of structure to be welded (for example, bodies of various models of motor vehicle, or bodies of different versions, such as saloons, station wagons, cabriolets, etc., of the same model of motor vehicle, or again, for example, individual sub-assemblies, such as the floor panel or sides, of various models of motor-vehicle body). There are known systems of the type specified above (see, for example, GB-A-2 172 555 and EP-A-0 642 878, filed in the name of the present applicant), which comprise:

a welding station;

a conveying line, for carrying through the welding station the structures to be welded or at least part thereof; and

a plurality of pairs of side frames, which are provided with means for clamping the structures to be welded during welding and can be guided along the conveying line, the clamping means provided on the side frames of each pair being adapted to the configuration of a corresponding type of structure to be welded.

In the above known systems, the side frames are movable on guide means provided at the side of the conveying line, to enable replacement, according to the type of structure to be welded, of the pair of side frames that is located near the welding station. Each side frame is displaceable between one first position, close to the welding station, and at least one second position, remote with respect to the welding station.

In addition, when each pair of side frames is in the aforesaid first position close to the welding station, it is displaceable between an open condition and a closed condition, in the latter of which the respective means of clamping of the side frames are operative for clamping parts of the structure to be welded in a welding configuration in the welding station. The system moreover comprises means for moving the side frames, for their displacement between the respective first and second positions.

In order to facilitate use of various types of side frames, it is likewise known to equip the system with one or more magazines of side frames, each comprising one or more parking stations both upstream and downstream of the welding station, with reference to the direction of advance along the line, each station comprising a guide section designed to support a side frame in a slidable way.

Thanks to the pre-arrangement of the magazines of side frames, it is possible for a station to operate in a flexible way on a large number of various types of structure to be welded.

### SUMMARY OF THE INVENTION

The purpose of the present invention is to improve further the known systems by further increasing their degree of flexibility and the productivity of the line. A further purpose is to provide a system that will be able to achieve the aforesaid objectives with relatively simple and reliable means.

With a view to achieving the above and further purposes, the subject of the invention is a welding system of the type that has been specified above, characterized moreover in that it comprises auxiliary guide means that connect directly at least one guide section of a magazine situated upstream of the welding station with a guide section of a magazine situated downstream of the welding station so as to enable transfer of side frames directly from the magazine upstream to the magazine downstream, and vice versa.

Thanks to the characteristic referred to above, during operation of the welding station it is possible to guarantee that in any operating condition and in particular whatever the succession of the various types of structure to be welded that advances through the welding station, the system will always be able to find each time the pair of side frames that are necessary in the most advantageous position to enable it to be brought into the working position before the corresponding type of structure to be welded arrives in the station, so as to guarantee that no dead times are required for pre-arrangement of the frames that are necessary in the welding position and so as to able, when a structure of a type different from the one previously welded enters the welding station, to replace the side frames previously used with the new pair of side frames that is necessary in a time not longer than the time of alternation of the bodies to be welded in the station.

### BRIEF DESCRIPTION OF THE DRAWINGS

The invention will now be described with reference to the annexed plate of drawings, in which:

FIG. 1 is a schematic view of a first example of embodiment of the system according to the invention; and

FIG. 2 is a perspective, once again schematic, view, of a variant of the system of FIG. 1.

### DETAILED DESCRIPTION OF THE INVENTION

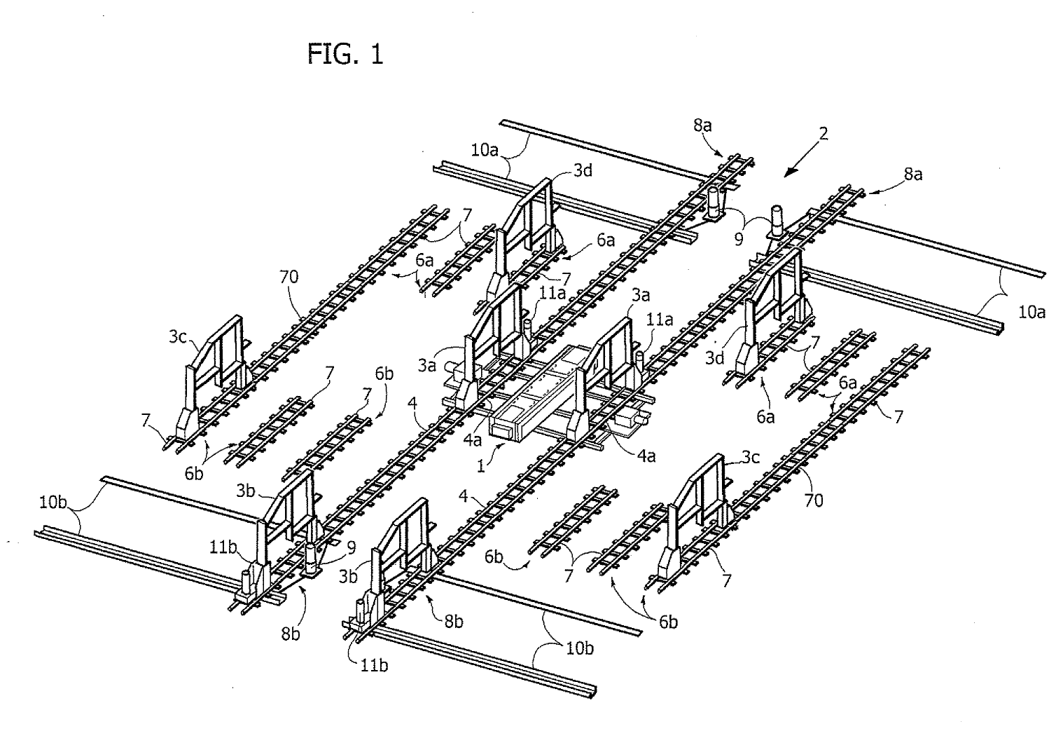

FIG. 1 illustrates a welding system for motor-vehicle bodies that to a major extent corresponds to the system known from the preceding European patent application No. EP-A-1 611 991, filed in the name of the present applicant.

The system comprises a welding station 1 set along a conveying line (represented only schematically by the arrow 2), used for carrying the bodies to be welded through the welding station 1. The station 1 is not illustrated in detail in so far as it is of a conception that is as a whole known, with the exception of some of its specific innovative aspects, which will be described in what follows. The welding equipment provided in the station 1 can be constituted by robots of a known type (not illustrated in FIG. 1), the control unit of which contains a set of different operating programs, selected each time according to the type of body to be welded.

Given that the conveying line 2 and the means for obtaining displacement of the bodies along it can be of any known type, said elements are not illustrated in the annexed plate of drawings in so far as they do not fall within the scope of the present invention. Their elimination from the drawings moreover renders the latter more immediately understandable. It is evident in any case that the way in which the body to be welded is formed in the welding station can be any whatsoever. For example, the body can be entirely pre-assembled in a provisional way upstream of the welding station. Or else, the various sub-assemblies forming the body can be carried on the conveying line 2 to the welding station in an as yet non-assembled condition, assembly prior to welding being performed in the station itself. Or yet again, the conveying line 2 can carry only part of the body, for example the floor panel, to the welding station, in which case the assembly of the complete body is performed in the welding station, getting the remaining components of the body to arrive there. Again, the system of the invention is of course usable also for welding individual sub-assemblies of body, or again in theory for any other type of welded sheet-metal structure that is to be produced in various types or models or versions. Whatever the way in which the body is assembled, it is necessary to clamp each part of the body in a precise position when the body undergoes the operations of welding in the station 1. Said clamping is obtained by means of tools for positioning and clamping, carried by pairs of side frames that are operatively interchangeable with one another, designated by 3a, 3b, 3c and 3d in FIG. 1, which can run on longitudinal bottom rails or guides 4; where not strictly necessary for a detailed description of the operation of the system according to the invention, the side frames 3a, 3b, 3c, and 3d will in what follows be identified just by the reference number 3.

In the case exemplified, the guides 4 extend parallel to the line 2 for conveying the bodies and are fixed directly to the floor, with the exception of their respective intermediate portion, designated by 4a, located in a position corresponding to the welding station 1. As will emerge clearly from what follows, the portions 4a of the guides 4 can be translated in a direction substantially perpendicular to the longitudinal development of the guides themselves, for carrying the side frames 3 of the pair in use into the welding station 1 in the respective closed condition.

The pairs of frames 3 can be displaced along the guides 4 so as to carry into a position corresponding to the welding station 1a pair of side frames corresponding to the type of body to be welded. When a body of a type different from the one on which the welding station has been operating immediately before reaches the station 1, the pair of side frames that is located in the station can be rapidly replaced by sliding on the respective guides 4, as will emerge from what follows.

To increase the flexibility of the welding station and in particular increase the number of different types of body on which the station is able to operate, in the case exemplified, two magazines of frames are provided, situated, respectively, upstream and downstream of the welding station, with reference to the direction of advance along the line 2. Each of the two magazines of frames comprises a series of stations 6a and 6b, arranged at the two sides of the conveying line 2 and of the guides 4, where each station comprises a guide section 7 having a shape similar to the guides 4 and thus designed to support a corresponding side frame in a slidable way. In the case exemplified, the guide sections 7 extend substantially parallel to the guides 4.

In the example illustrated, both the magazine upstream and the magazine downstream have two sections of magazine at the two sides of the conveying line 2, each comprising three different stations 6a, 6b, which corresponds to a maximum total number of six different types of frames 3 that are to operate on as many types of body. Of course, in any case, the two magazines can be provided with any number of parking stations, with the limits that will be illustrated in what follows.

The various frames 3 carry, in a way in itself known, respective positioning tools for clamping (not illustrated), designed to engage the side and top parts of the body, in such a way as to clamp it in a precise position during execution of the operations of welding in the station 1. The bottom part of the body is instead clamped by means of further positioning tools for clamping, prearranged on the bottom part of the welding station 1. Each pair of side frames 3 is in particular provided with positioning tools for clamping suited to the particular configuration of a respective type of body.

During use of the system, positioned each time on the guides 4 are a first pair of side frames 3, in the working position, corresponding to the type of body that is located each time in the welding station 1, and a second pair of frames 3, in a waiting position, corresponding to the type of the body to be welded immediately after. When the latter body enters the welding station 1, the first frames 3 are carried into a waiting position and the second frames 3 into the working position by means of a simultaneous movement in the longitudinal direction along the guides 4.

Provided in a position corresponding to the two longitudinal ends of the guides 4 are respective translatable guide elements 8a, 8b having a shape similar to that of the guides 4. The translatable guide elements 8a, 8b are equipped with respective motor-drive means 9 in order to be able to displace laterally, for example on respective pairs of rails 10a, 10b, in a direction perpendicular to the longitudinal development of the guides 4, between a first position and a plurality of second positions. In the aforesaid first position, each translatable guide element 8a, 8b is longitudinally aligned to a respective guide 4 so as to constitute a sort of prolongation thereof. By means of the aforesaid lateral displacement, each stretch 8a, 8b can be brought into a position corresponding to a respective parking station 6a, 6b, i.e., to a guide section 7.

Moving of the side frames 3 of the various pairs can be obtained in various ways. In a first embodiment, which corresponds to what is illustrated in FIG. 1, moving of the side frames 3 of the various pairs is obtained by means of independent tractors, each of which is able to co-operate with different side frames 3 in order to pick them up from a respective station 6a and 6b and bring them into the operating position in a position corresponding to the station 1 and vice versa. In the case illustrated in FIG. 1, two pairs of tractors are provided, designated by 11a and 11b, which are selectively coupleable to the various side frames.

The welding system described above corresponds to what is illustrated in the preceding European patent application No. EP-A-1 611 991, filed in the name of the present applicant. The general operation of said system is described in what follows. We shall assume that in the welding station 1 is a body of a first type referred to as type A, parts of which are clamped in a precise position during the operations of welding by positioning tools carried by the pair of side frames 3a. The body that is located in the welding station 1 is to be followed by a body of a second type, referred to as type B, where the positioning tools prearranged for clamping the various parts of the body of type B during execution of welding are prearranged on the pair of the side frames 3b. Likewise, we shall assume that the body of type B is followed by a body of a third type C, and this in turn by a body of a fourth type D, to each of which is associated a respective type of side frames 3c and 3d.

The replacement of one body in the welding station 1 with a body of a different type is accompanied by a corresponding replacement of the pairs of side frames to be used by the station itself along the guides 4, in such a way as to bring one pair of side frames 3 into a waiting position and the other pair of frames 3 into the operating position, corresponding to the welding station.

Once each pair of side frames has reached the operating position, it is displaceable between an open condition, to enable entrance into the welding station 1 of the new body to be welded, and a closed position, in which the positioning tools of the side frames engage the side and top parts of the body to clamp them in a precise position. As previously mentioned, the aforesaid movement is obtained via translation of the portions 4a of the guides 4. The clamping of the frames 3 in the closed condition, with respect to the welding station, is obtained via means in themselves known.

In FIG. 1, the bodies that advance along the line are not illustrated for reasons of clarity. As long as bodies of type A and B advance along the line, they are welded each time after prior longitudinal sliding of the two pairs of side frames 3a and 3b in such a way that each time one of said pairs reaches the operating position, and the other pair is brought into a waiting position, respectively upstream and downstream of the welding station. In the situation illustrated in FIG. 1, located in the operating position are the two side frames 3a, which means that the body that is located in the welding position is a body of type A. If, for example, after said body, a body of type C is to be welded, the two side frames 3b do not remain stationary in a waiting position, but instead advance longitudinally along the guides 4 up to the position illustrated in FIG. 1. In said condition, the guide sections 8b displace transversely along the guides 10b until they come into alignment with respective guides 7 of two stations 6b of the magazines. In this way, the side frames 3b can be brought into an inoperative position in the magazine, after which the guide sections 8b are aligned with the sections 7, on which they await the two side frames 3c. The latter can thus be taken on board the guide sections 8b, which displace once again transversely until they are aligned with the guides 4. In this way, the two side frames 3c can move into the waiting position, immediately downstream of the welding station, so that at the end of welding of the body of type A, they will be ready to translate longitudinally along the guides 4 and move into the operating position for intervention on the body of type C, which is entering the welding station.

As has already been said, the structure and operation described above are known from the preceding patent application No. EP-A-1 611 991, filed in the name of the present applicant. The embodiment of the present invention illustrated in FIG. 1 differs from what is known from the preceding application in that, in the case illustrated, the magazines upstream and downstream provided in the welding system are connected directly together by means of guide sections 70. In the specific case illustrated, just two guide sections 70 are provided, which connect together two guide sections 7 on the two sides of the welding station. It is not ruled out, however, that a greater number of connection sections 70 can be provided for connecting together more than two guide sections 7. As may be seen, the pre-arrangement of the guide sections 70 that connect directly together guide sections 7 belonging to magazines arranged upstream and downstream of the welding station enables conveying of a side frame from a magazine upstream of the station directly to the magazine downstream, or vice versa, without the need to pass the side frame through the longitudinal guides 4 arranged at the two sides of the welding station. In other words, guide lines 70 are provided that constitute a by-pass with respect to the longitudinal guides 4. Said solution enables the productivity of the system to be raised considerably and in particular guarantees once again the possibility of positioning a pair of side frames rapidly in the operating position, in whichever magazine station said side frames are arranged.

FIG. 1 refers to the case where, as in the preceding patent application filed in the name of the present applicant moving of the side frames is obtained by means of independent tractors 11a, 11b, which are able to move on the guides 4 and on the guide sections 7 and are able to engage with the side frames.

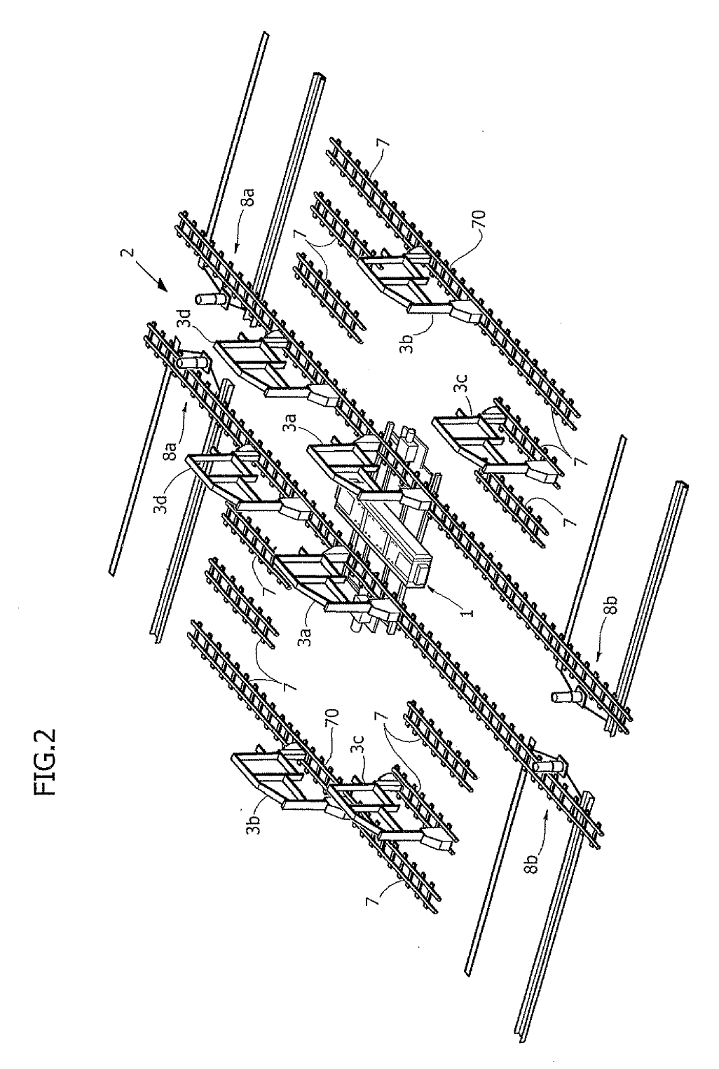

FIG. 2 illustrates a similar welding station, in which each side frame is provided with an autonomous motor drive of its own. Also in the case of FIG. 2, the robots R that carry the welding heads that are needed for carrying out the operations of welding on the body that each time is located in the welding station are not illustrated, and nor are the bodies that advance through the station illustrated.

FIG. 2 illustrates in particular a condition in which located along the guides 4 at the two sides of the line are two pairs of side frames and in which all the remaining types of side frames are located, positioned in the magazine downstream of the welding station. In the case of the example illustrated in FIG. 2, there are once again provided a total of four pairs of side frames that are to operate on four different types of body. At the instant illustrated in FIG. 2, located in the welding station is a body of type A, engaged by the pair of frames 3a, whilst the pair of side frames 3d are waiting. The magazine upstream is completely empty, and the side frames 3b that were in the magazine downstream, are in the course of transfer, via the guide sections 70, from the magazine downstream to the magazine upstream.

FIG. 2 differs then from FIG. 1 in that, in the system illustrated therein, no frame 3 is carried by a self-driven trolley.

As may be seen, the principle that underlies the present invention is that of creating a direct connection between the magazine upstream of the welding station and the magazine downstream of the welding station, so as to make it possible to carry side frames positioned in one of said magazines into the other magazine directly, and vice versa, without passing through the guides 4 arranged at the two sides of the welding station.

Of course, without prejudice to the principle of the invention, the details of construction and the embodiments may vary widely with respect to what is described and illustrated herein, without thereby departing from the scope of the present invention.

In particular, the structure, conformation, and operation of the welding station can also be different from the ones illustrated above, and the same also applies to the number, conformation, and arrangement of the magazines of side frames.

What is claimed is:

1. A system for welding structures constituted by elements of stamped sheet metal, such as motor-vehicle bodies or their sub-assemblies, designed to operate automatically on a plurality of different types of structures to be welded, of the type comprising:
a welding station;
a conveying line for carrying through the welding station the structures to be welded or at least part thereof;
a plurality of pairs of side frames, which are provided with means for clamping the structures to be welded and can be guided along the conveying line, the clamping means provided on the side frames of each pair being adapted to the configuration of a corresponding type of structure to be welded,
wherein the side frames are movable on guide means, provided at the side of the conveying line, to enable replacement, according to the type of structure to be welded, of the pair of side frames that is located at the welding station, each side frame being displaceable between a first position, close to the welding station and at least one second position, remote with respect to the welding station, and
wherein, when each pair of side frames is located in said first position close to the welding station, it is moreover displaceable between an open position and a closed position, in which the respective side frames are operative for clamping parts of the structure to be welded in a welding configuration on the welding station,
the system moreover comprising means for moving the side frames for their displacement between the respective first and second positions,
wherein there are provided one or more magazines of frames, each comprising one or more parking stations, both upstream and downstream of the welding station, each station comprising a guide section designed to support a side frame in a slidable way in its second position,
said system being characterized in that auxiliary guide means are provided that connect directly at least one guide section of a magazine upstream of the welding station with a guide section of a magazine downstream of the welding station, in such a way as to enable transfer of pairs of side frames directly from the magazine upstream to the magazine downstream, or vice versa, without passing them through the welding station.

2. The welding system according to claim 1, wherein said means for moving comprise a plurality of tractors, which are autonomous with respect to said side frames, each tractor being selectively coupleable automatically to side frames of different pairs, in order to displace the latter.

3. The welding system according to claim 1, wherein said means for moving comprise motor means associated to each side frame.
